(19) United States
(12) Patent Application Publication
(10) Pub. No.: US 2007/0193691 A1
(43) Pub. Date: Aug. 23, 2007

(54) Laminating machine

(75) Inventors: Amer Arafat, Madison, WI (US); Frank Wadzinski, Poynette, WI (US); Jay Yang, Madison, WI (US)

Correspondence Address: MICHAEL BEST & FRIEDRICH, LLP, 100 EAST WISCONSIN AVENUE, SUITE 3300, MILWAUKEE, WI, 53202, US

(73) Assignee: General Binding Corporation, Northbrook, IL (US)

(21) Appl. No.: 11/358,300

(22) Filed: Feb. 20, 2006

(51) Int. Cl. B32B 37/00

(52) U.S. Cl. 156/552; 156/580

(57) ABSTRACT

A laminating machine configured to apply a film to a media. The laminating machine includes a pair of first rollers that define an in-feed nip, and a pair of second rollers that define an out-feed nip. The laminating machine further includes a threading member movable from the in-feed nip toward the out-feed nip, and wherein the threading member is configured to engage the film.

### BACKGROUND

The present invention relates to laminating machines, and more specifically to the arrangement of the rollers of laminating machines, as well as threading laminating machines.

Laminating machines are used to apply a film, typically formed from such materials as nylon, polyester, polyethylene, polypropylene, etc., to a media that can include paper, cardboard, poster board, etc. Generally, laminating machines include a pair of main rollers, a pair of pull rollers, and an arrangement of tension idlers. The film is commonly stored on a roll and is typically applied to both sides of the media. Such, laminating machines utilize upper and lower rolls of film. The upper and lower films are threaded through the laminating machine by threading a free end of the film around the tension idlers, between the main rollers, known as the main roller nip, and between the pull rollers, known as the pull roller nip.

During operation of the laminating machine, one of the main rollers is generally driven and the media is fed through the main roller nip. When using heat activated film, the main rollers are heated to activate an adhesive contained on a surface of the films, and a combination of the compressive force of the main rollers and the activated adhesive bonds the upper and lower films to the media. The pull rollers pull the media and film through the laminating machine.

### SUMMARY

In one embodiment, the invention provides a laminating machine configured to apply a film to a media. The laminating machine includes a pair of first rollers that define an in-feed nip, and a pair of second rollers defining an out-feed nip. The laminating machine further includes a threading assembly having at least one auxiliary roller located between the first pair of rollers and the second pair rollers. The auxiliary roller is operable to move a portion of the film from the first roller toward the second roller.

In another embodiment the invention provides a laminating machine configured to apply a film to a media. The laminating machine includes a pair of first rollers defining an in-feed nip, and a pair of second rollers defining an out-feed nip. The laminating machine further includes a threading member movable from the in-feed nip toward the out-feed nip, and wherein the threading member is configured to engage the film.

Other aspects of the invention will become apparent by consideration of the detailed description and accompanying drawings.

### BRIEF DESCRIPTION OF THE DRAWINGS

FIG. 1 is a perspective view of a laminating machine with a conventional roller arrangement embodying the present invention with one sidewall of the laminating machine removed for clarity.

FIG. 2 is a partial side view of the laminating machine of FIG. 1.

FIG. 3 is a perspective view of a laminating machine with an offset roller arrangement embodying the present invention with one sidewall of the laminating machine removed for clarity.

FIG. 4 is a partial side view of the laminating machine of FIG. 3 illustrating the threading of the laminating machine.

FIG. 5 is a partial side view illustrating the laminating machine of FIG. 3 with a media lock assembly in a first position.

FIG. 6 is an enlarged partial side view of a portion of the laminating machine of FIG. 3 showing the media lock assembly in the first position.

FIG. 7 is a partial side view of the laminating machine of FIG. 3 with the media lock assembly in a second position.

FIG. 8 is an enlarged partial side view of a portion of the laminating machine of FIG. 3 showing the media lock assembly in the second position.

FIG. 9 is an exploded perspective view of another construction of a laminating machine embodying the present invention with the housing of the laminating machine removed for clarity.

FIG. 10 is a partial side view of the laminating machine of FIG. 9.

FIG. 11 is a partial side view of an alternative construction of the laminating machine of FIG. 9.

FIG. 12 is a partial side view of the laminating machine of FIG. 11 in an alternative mode of operation.

FIG. 13 is a partial side view of the laminating machine of FIG. 3 that includes the threading assembly of FIG. 11.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The present invention will be described with reference to the accompanying drawing figures wherein like numbers represent like elements throughout. Certain terminology, for example, “inner”, “outer”, “top”, “bottom”, “upper”, “lower”, “above”, “below”, “upward”, “downward”, “vertical”, “horizontal”, “right”, “left”, “front”, “frontward”, “forward”, “back”, “rear”, and “rearward” is used in the following description for relative descriptive clarity only and is not intended to be limiting.

### DETAILED DESCRIPTION

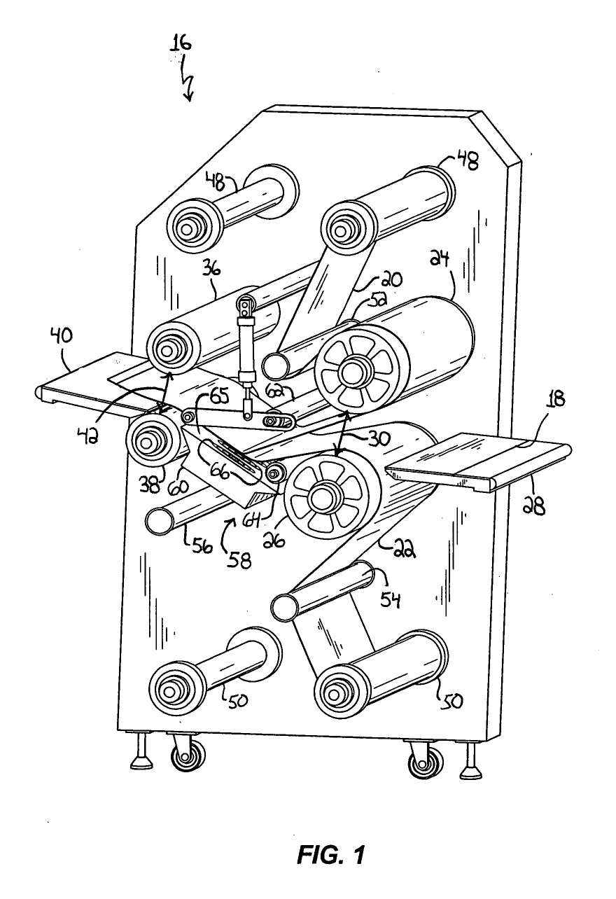

FIG. 1 illustrates a laminating machine 16 configured to laminate a media 18 such as paper, poster board, cardboard, etc., with upper and lower translucent films 20, 22. The laminating machine 16 includes an upper main roller 24 and a lower main roller 26 that together define an in-feed end of the laminating machine, and an in-feed table 28 that is located adjacent to the in-feed end of the laminating machine 16. The main rollers 24, 26 are each rotatable about an axis and in one construction the lower main roller 26 is driven about its axis by a drive member, such as a motor or other suitable device, while the upper main roller 24 free wheels about its axis. In other constructions, the upper main roller 24 can be driven rather than the lower main roller 26 and in yet other constructions, both main rollers 24, 26 can be driven.

An in-feed or main roller nip 30 is defined as the distance between outer surfaces of the upper and the lower main rollers 24, 26. The main roller nip 30 is adjustable by moving the axes of the main rollers 24, 26 relative to each other, and in the illustrated construction, the lower main roller 26 is fixed while the upper main roller 24 can move in a generally vertical direction to adjust the main roller nip 30. FIG. 1 illustrates the main rollers 24, 26 at their maximum separated distance (i.e. maximum nip), and in one construction the maximum main roller nip is approximately 4 inches. In other constructions the maximum main roller nip can be more or less than 4 inches.

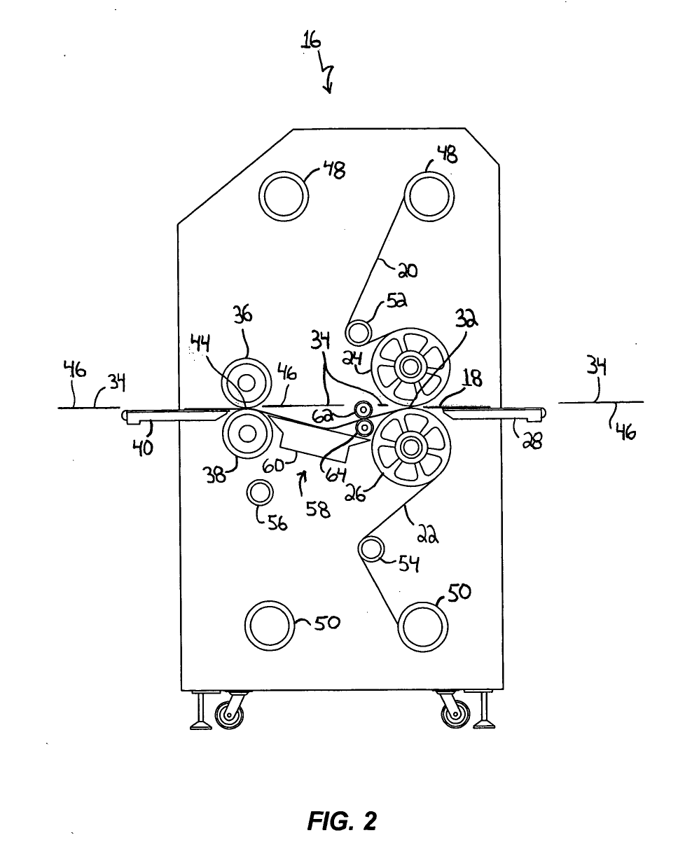

Referring to FIG. 2, the main roller nip 30 can be decreased until the upper main roller 24 contacts the lower main roller 26 (i.e. closed nip), and the upper main roller 24 can be further biased toward the lower main roller 26 until a desired pressure is created between the upper and lower main rollers 24, 26. An in-feed nip point 32 is defined on each of the main rollers 24, 26 as the point where the main rollers 24, 26 contact each other when the in-feed nip 30 is closed, and a main roller plane 34 is defined as a plane that is tangent to the upper and lower main rollers 24, 26 at the in-feed nip point 32.

The main rollers 24, 26 each include an internal heating element that is operable to heat the outer surfaces of the main rollers 24, 26. In one construction, the heating elements heat the outer surfaces of the main rollers 24, 26 between ambient temperatures to approximately 300° F. In other constructions, the heating elements may heat the main rollers 24, 26 to a temperature either greater than or less than 300° F. depending on the particular application of the laminating machine 16 and the film 20, 22 utilized by the laminating machine 16. In other constructions, the main rollers 24, 26 may omit the heating elements, and in such constructions, the heating element can be located at different locations within the laminating machine 16. In yet other constructions, the laminating machine 16 may not include the heating element.

Referring to FIGS. 1 and 2, the laminating machine 16 further includes an upper pull roller 36 and a lower pull roller 38 that together define an out-feed end of the laminating machine 16, and an out-feed table 40 that is located adjacent the out-feed end of the laminating machine 16. The upper and lower pull rollers 36, 38 are each rotatable about an axis, and in one construction both the upper and lower pull rollers 36, 38 are driven about their axes by the drive member. In other constructions, either the upper or lower pull roller 36, 38 can be driven by the drive member while the other pull roller free wheels. In the illustrated construction, the upper and lower pull rollers 36, 38 are driven by the same drive member as the lower main roller 26. In such constructions, the laminating machine 16 can include flexible members, such as belts, chains, and the like to connect the main and pull rollers 24, 26, 36, 38 to the drive member. Furthermore, the main and pull rollers 24, 26, 36, 38 may each include a clutch, or other suitable member, to ensure that the films 20, 22 travel through the laminating machine 16 at generally the same speed. In yet other constructions, there can be more than one drive member each configured to drive one or more of the main rollers 24, 26 and pull rollers 36, 38.

An out-feed or pull roller nip 42 is defined as the distance between outer surfaces of the pull rollers 36, 38, and the pull roller nip 42 is adjustable by moving the axes of the pull rollers 36, 38 relative to each other. In the illustrated construction, the lower pull roller 38 is fixed while the upper pull roller 36 can move in a generally vertical direction to adjust the pull roller nip 42. FIG. 1 illustrates the pull rollers 36, 38 at the maximum pull roller nip 42, and in one construction, the maximum pull roller nip 42 is approximately 4 inches. In other constructions, the maximum pull roller nip can be more or less than 4 inches.

Referring to FIG. 2, a closed pull roller nip 42 is achieved by decreasing the distance between the pull rollers 36, 38 until the upper pull roller 36 contacts the lower pull roller 38. The upper pull roller 36 can be further biased toward the lower pull roller 38 until a desired pressure is created between the pull rollers 36, 38. An out-feed nip point 44 is defined on each of the pull rollers 36, 38 as the point where the pull rollers 36, 38 contact each other when the out-feed nip 42 is closed, and a pull roller plane 46 is defined as a plane that is tangent to both the lower and upper pull rollers 38, 36 at the out-feed nip point 44.

In the embodiment shown in FIG. 2, the pull rollers 36, 38 and the main rollers 24, 26 are arranged such that the pull roller plane 46 is co-planar with the main roller plane 34, and in other constructions, the pull roller plane 46 is parallel to, but either above or below the main roller plane 34. These arrangements of the main rollers 24, 26 and the pull rollers 36, 38 are known in the art and will hereinafter be referred to as a conventional roller arrangement.

With continued reference to FIGS. 1 and 2, the illustrated laminating machine 16 further includes upper unwinders 48 and lower unwinders 50. The upper and lower unwinders 48, 50 are rotatable about an axis and are each configured to support a roll of the films 20, 22. In the illustrated construction, the laminating machine 16 utilizes two rolls of film, an upper roll of the film 20 and a lower roll of the film 22. The upper roll of the film 20 is rotatably supported by one of the upper unwinders 48, and the lower roll of the film 22 is supported by one of the lower unwinders 50 depending on whether the laminating machine 16 is being operated in a forward direction or in a reverse direction. It should be understood that FIGS. 1 and 2 illustrate just one possible orientation of the upper and lower unwinders 48, 50, and in other constructions the laminating machine 16 may include the upper and lower unwinders 48, 50 positioned at other suitable locations. In yet other constructions, the laminating machine may include any suitable number of upper and lower unwinders depending on the application of the laminating machine.

The illustrated laminating machine 16 further includes an upper tension idler 52, a front lower tension idler 54, and a rear lower tension idler 56 that correspond to the upper unwinders 48 and the lower unwinders 52. While the tension idlers 52, 54, 56 of FIGS. 1 and 2 are illustrated in their operating position, the tension idlers 52, 54, 56 can be retractable to a temporary position in order to facilitate threading the upper and lower films 20, 22.

As is understood by one of skill in the art, FIGS. 1 and 2 illustrate the tension idlers 52, 54, 56 in just one possible operating location, and the tension idlers 52, 54, 56 can be located at virtually any position to achieve a desired tension in the films 20, 22 and/or angle of wrap of the films 20, 22 around the main rollers 24, 26 and pull rollers 36, 38. In yet other constructions, the laminating machine may include any suitable number of tensions idlers.

Referring to FIG. 1, the upper and lower rolls of the films 20, 22 utilized by the laminating machine 16 contain a limited supply of the film 20, 22. Therefore, the user of the laminating machine 16 periodically changes the upper and lower rolls of the films 20, 22. One possible method of changing the film rolls includes placing new rolls of the film 20, 22 on the desired upper and lower unwinders 48, 50, and moving the main rollers 24, 26 and pull rollers 36, 38 to their maximum nip positions. Then, the upper and lower films 20, 22 are threaded through the laminating machine 16. To thread the lower film 22, a free end of the film 22 is threaded from the lower unwinder 50, up and around the lower tension idler 54, around the lower main roller 26, and through the main roller nip 30. The user would then go to the rear of the laminating machine 16 and pull the free end of the lower film 22 through the pull roller nip 42. Similarly, a free end of the upper film 20 is threaded around the upper tension idler 52, around the upper main roller 24, through the main roller nip 30, and then, from the rear of the laminating machine 16, the user pulls the upper film 20 through the pull roller nip 42. With the upper and lower films 20, 22 threaded through the laminating machine 16 as illustrated in FIG. 1, the main and pull roller nips 30, 42 are closed in order to begin using the laminating machine 16 to laminate the media 18.

Referring to FIGS. 1 and 2, to assist the user in threading the laminating machine 16, the laminating machine 16 of the present invention includes a threading assembly 58. The illustrated threading assembly 58 includes a table 60 and a pair of auxiliary or push rollers 62, 64. The table 60 is located between the main rollers 24, 26 and the pull rollers 36, 38 and has a media supporting surface 65 that is titled at an angle with respect to the main and pull roller planes 34, 42. The illustrated table 60 is a vacuum table that includes an air handling unit, such as a fan, blower, or other suitable device that is located below the media supporting surface 65 and is operable to draw air through a series of slits 66 that extend through the media supporting surface 65.

The pair of auxiliary or push rollers 62, 64 includes an upper push roller 62 and a lower push roller 64 that are located adjacent the main rollers 24, 26, between the main rollers 24, 26 and the pull rollers 36, 38. The exterior surfaces of the upper and lower push rollers 62, 64 are coated with silicon rubber, or other suitable materials, to provide increased friction with the films 20, 22. In the illustrated construction, the lower push roller 64 is driven about its axis and is held in a fixed position. The upper push roller 62 free wheels about its axis and is movable in a generally vertical direction with respect to the lower push roller 64 to adjust a push roller nip defined as the distance between the push rollers 62, 64. FIG. 1 illustrates the push rollers 62, 64 at a maximum push roller nip while FIG. 2 illustrates a closed push roller nip.

To operate the threading assembly 58, the main rollers 24, 26, the pull rollers 36, 38, and the push rollers 62, 64 are placed in the maximum nip positions. Then, both free ends of the lower and upper films 20, 22 are threaded around their respective tension idlers 54, 52 and main rollers 24, 26, and through the main roller nip 30 and the push roller nip. The push roller nip is closed and the lower push roller 64 is turned to the on position such that the lower push roller 64 is driven to push the free ends of the upper and lower films 20, 22 toward the pull roller nip 42. Meanwhile, the air handling unit draws air through the slits 66 to substantially prevent the free ends of the upper and lower films 20, 22 from curling while still allowing the films 20, 22 to travel along the media supporting surface 65 and into and through the pull roller nip 42. While the illustrated table 60 is a vacuum table, in other constructions, the table can be an electrostatic table that is configured to movably couple the films 20, 22 thereto.

With the upper and lower films 20, 22 threaded, the main roller nip 30 and the pull roller nip 42 are closed and the laminating machine 16 can be utilized to laminate the media 18 with the upper and lower films 20, 22. During lamination, the push roller nip can remain closed to allow the push rollers 62, 64 to operate as lay-on rollers. In the closed nip positions, the push rollers 62, 64 are located immediately behind the main roller nip point 32, and the films 20, 22 exits the main roller nip 30 substantially heated such that the push rollers 62, 64 substantially remove imperfections (i.e., waves, wrinkles, bubbles, etc.) from the films 20, 22.

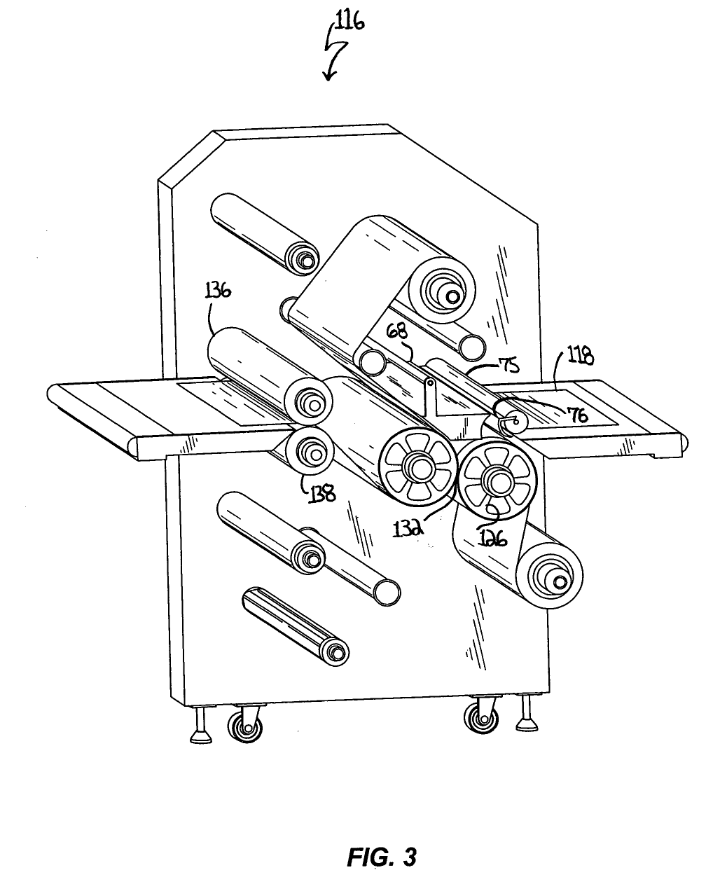

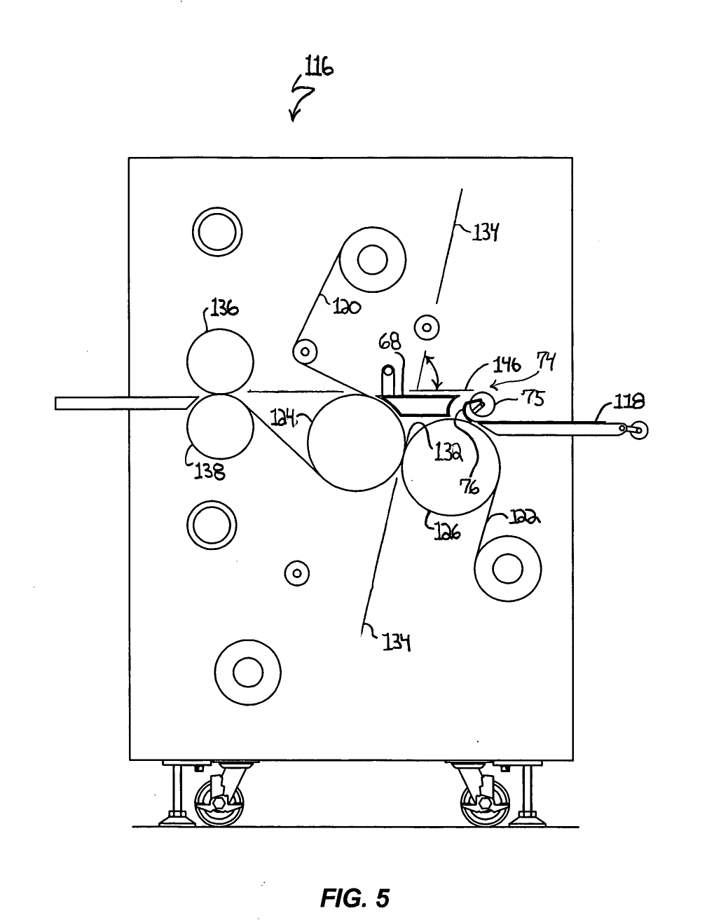

FIGS. 3-8 illustrate another construction of a laminating machine 116 that includes the main rollers 124, 126 arranged in an offset roller arrangement. In one construction of the offset roller arrangement, the lower main roller 126 is located at relatively the same location as the lower main roller 26 in the conventional roller arrangement. However, in the offset roller arrangement the upper main roller 124 is moved downwardly and rearwardly toward the pull rollers 136, 138. While the conventional roller arrangement includes the main roller plane 34 generally parallel and/or co-planar with the pull roller plane 46, the offset roller arrangement includes the main roller plane 134 at an angle α relative to the pull roller plane 146. As illustrated in FIG. 5, the offset angle α is measured from the pull roller plane 146 counterclockwise to the main roller plane 134, and in the illustrated construction, the offset angle α is approximately 75 degrees. In other constructions, the offset angle α can be any suitable angle depending on the application of the laminating machine and arrangement of the main and pull rollers. For example, the offset angle α can be greater than 30 degrees.

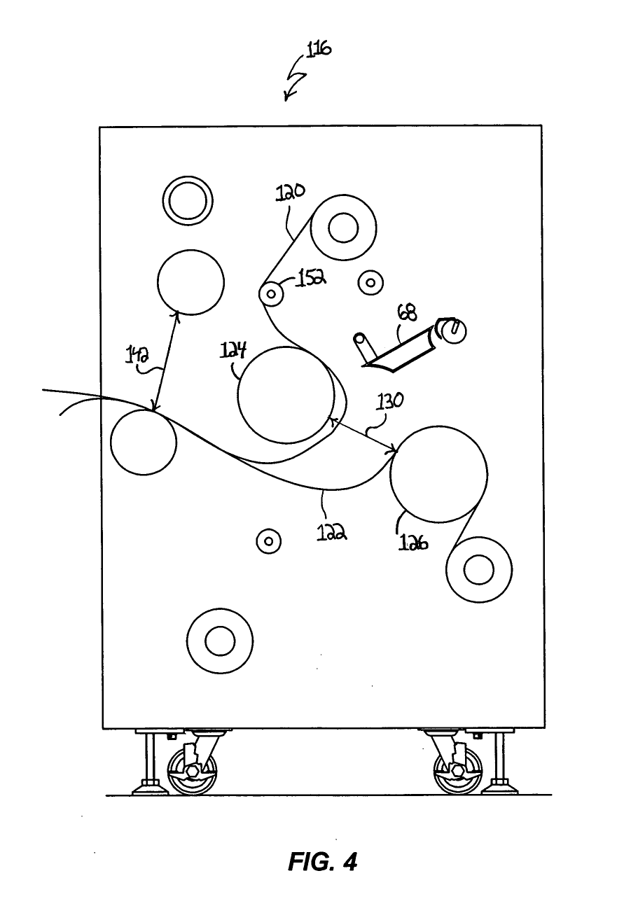

Referring to FIGS. 4 and 5, a removable main roller guard 68 is located above the in-feed nip point 132. The main roller guard 68 substantially prevents access to the in-feed nip point 132 and to the lower main roller 126 from above. The main roller guard 68 is rotatably coupled to the laminating machine 116 such that the main roller guard 68 can be rotated upwardly to facilitate threading the upper and lower films 120, 122 through the main roller nip 130.

In the illustrated construction of the offset roller arrangement, both main rollers 124, 126 are driven by the drive member. Furthermore, each of the main rollers 124, 126 includes a clutch or overdrive that is operable to maintain a rotational speed of the roller 124, 126 such that the upper and lower films 120, 122 are fed through the laminating machine 116 at substantially the same speed. Feeding the upper and lower films 120, 122 through the laminating machine 116 at substantially the same speed reduces curling of the final laminated product.

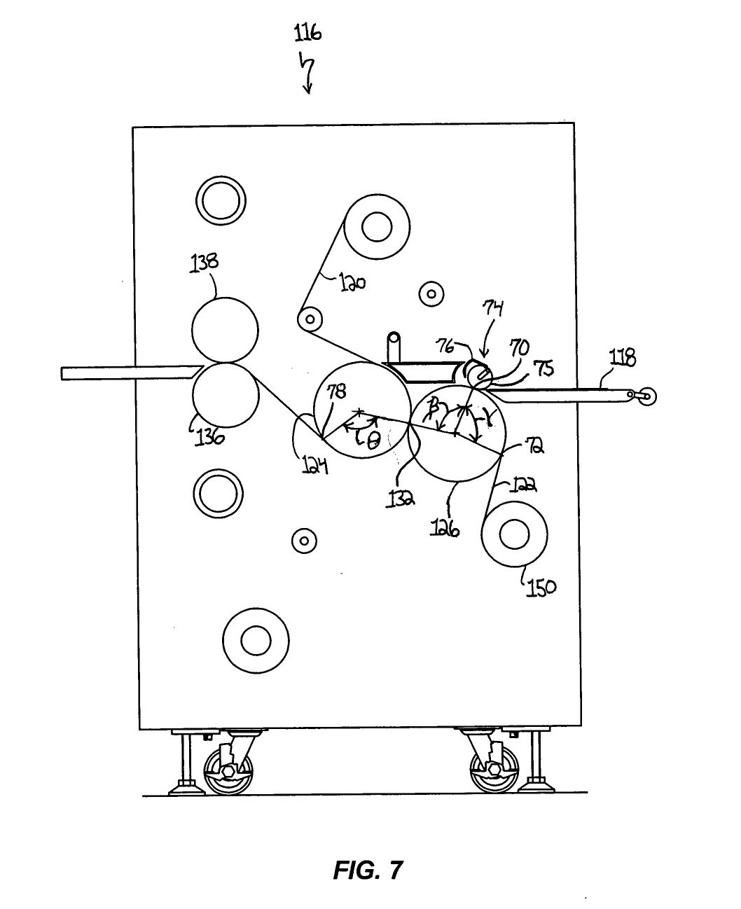

Referring to FIG. 7, the offset roller arrangement allows for an in-feed location 70 that is offset from the in-feed or main roller nip point 132. The in-feed location 70 is defined as a point on the outer surface of the lower main roller 126 where the couple media 118 and film 122 first contacts the lower main roller 126. Recall, the in-feed nip point 132 is defined as the point on each of the main rollers 124, 126 where the main rollers 124, 126 contact each other when the main roller nip 130 is fully closed. An in-feed angle β is defined as the angle between a line that extends from the center of the lower main roller 126 to the in-feed location 70 and a line that extends from the center of the lower main roller 126 to the in-feed nip point 132. In the construction of FIG. 7, the in-feed angle β is approximately 100 degrees whereas in the conventional roller arrangement, the in-feed angle is nearly 0 degrees. In other construction of the offset roller arrangment, the in-feed angle can be any suitable angle greater than about 10 degrees. For example, the in-feed angle β can be greater than about 20 degrees.

With continued reference to FIG. 7, a film contact point 72 is defined as the point on the outer surface of the lower main roller 126 where the second side of the film 122 first contacts the lower main roller 126. A film contact angle γ is defined as the angle between a line that extends from the center of the lower main roller 126 to the film contact point 72 and the line that extends from the center of the lower roller to the in-feed location 70. In the illustrated construction, the film contact angle γ is approximately 100 degrees. In other constructions, the film contact angle γ can be any suitable angle depending upon, among other things, the type of film utilized by the laminator machine 116. One type of film utilized by the laminating machine 116 is a heat activated film that includes a heat activated adhesive on the first side of the film 122. Therefore, as the film 122 travels through the film contact angle γ along the heated lower roller 126, the adhesive becomes tacky such that when the media 118 contacts the first side of the film 122 at the in-feed location 70, the media 118 is secured to the film 122 thereby securing the registration or alignment of the media 118 with respect to film 122 and the main rollers 124, 126. FIG. 7 illustrates just one possible film contact angle γ, and the film contact angle γ can be varied by repositioning tension idlers or the lower unwinder 150 to correspond to type of film utilized by the laminating machine 116 to ensure that the adhesive has been at least partially activated prior to the in-feed location 70.

Referring to FIGS. 5-8, the offset roller arrangement allows for the use of a media lock assembly 74 located adjacent the in-feed location 70. The media lock assembly 74 includes a pressing device 75 and a media guard 76 that is rotatable about an axis. In the illustrated construction, the pressing device 75 is a roller that rotates about an axis, and in other constructions the pressing device can be any suitable device configured to press the media 118 onto the film 122.

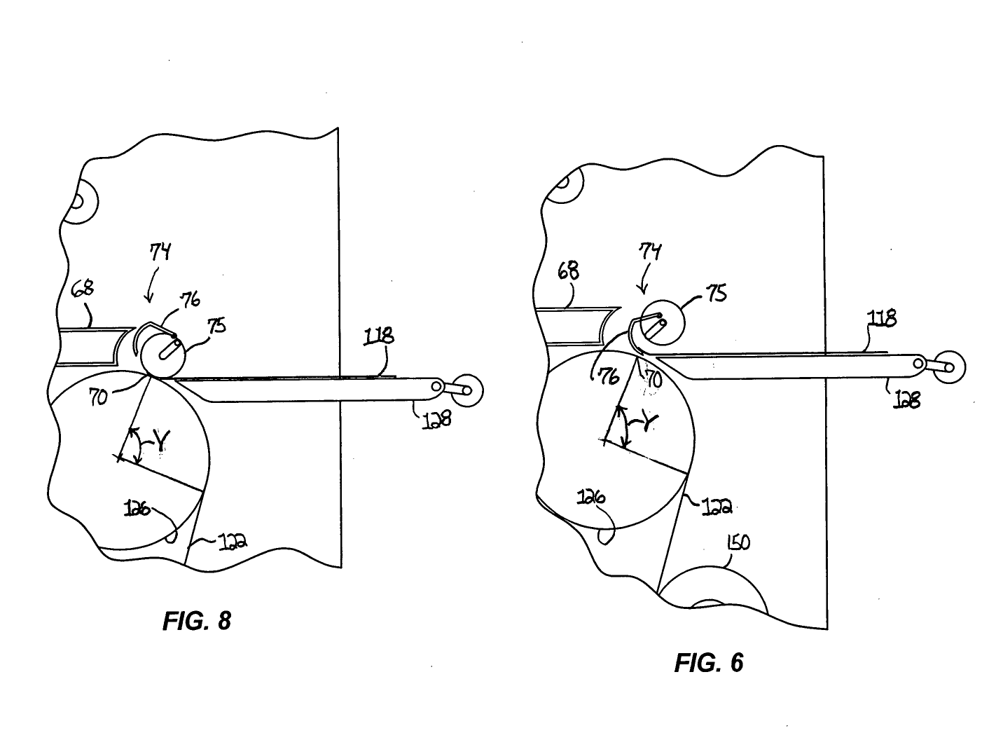

The pressing device 75 and the media guard 76 are movable from a first position (FIGS. 5 and 6) to a second position (FIGS. 7 and 8). In the first position, the pressing device 75 and the media guard 76 are in a retracted position such that neither the media guard 76 nor the pressing device 75 contacts the lower main roller 126 or the lower film 122. Furthermore, with the guard 76 in the first position, the media 118 is unable to enter the main roller nip 130. In the second or engaged position the pressing device 75 is moved toward the lower main roller 126 such that the pressing device 75 contacts the media 118 pressing it onto the lower film 122 while the media guard 76 rotates upward about its axis.

In operation of the media lock assembly 75, the media 118 is placed on the in-feed table 128 with a leading end of the media 118 positioned between the media guard 76 and the pressing device 75 (FIGS. 5 and 6). Then, the media 118 is aligned in the desired position while the media guard 76 prevents contact between the media 118 and the tacky first side of the film 122. Generally, it is desirable to register or align the leading edge of the media 118 parallel with the main rollers 124, 126 in order that the entire width of the leading edge of the media 118 enters the main roller nip 130 at substantially the same time. In one construction, the in-feed table 128 includes several horizontal lines that are parallel to the main roller nip 130 to facilitate proper registration of the media 118. With the media 118 aligned, the media lock assembly 74 is moved from the first position to the second position. In the second position (FIGS. 7 and 8), the pressing device 75 presses the media 118 onto the lower film 122. As a result of the film contact angle γ, the first side of the film 122 is tacky at the in-feed location 70. Therefore, when the media 118 contacts the first side of the film 122, the media 118 is substantially secured to the film 122 to ensure proper registration or alignment with the film 122 and the main roller nip 130 prior to encapsulation of the media 118 between the upper and lower films 120, 122 at the main roller nip location 132. The lower main roller 126 then rotates to feed the media 118 between the pressing device 75 and the lower film 122. After the media 118 has been secured onto the lower film 122, the pressing device 75 and the media guard 76 are retracted to the first position.

Positioning the main rollers 124, 126 in the offset arrangement can allow the laminating machine 116 to be operated at an increased speed while maintaining the same dwell time. As is understood by one of skill in the art, the dwell time is the amount of time that the films, with the media located therebetween, contact the main rollers.

As a result of the offset main rollers 124, 126, the films 120, 122 and media 118 have an increased angle of contact with the heated main rollers 124, 126, thereby allowing the user to increase the speed at which the films 120, 122 and media 118 travels across the rollers 124, 126 while maintaining the same dwell time. In the construction illustrated in FIG. 7, together the media 118 and the lower film 122 contact the heated lower main roller 126 for the in-feed angle β that is approximately 100 degrees. Then, after encapsulation of the media 118, the lower film 122 and the upper film 120 wrap around the heated upper main roller 124 for an encapsulation angle β that is defined as the angle between a line that extends from the center of the upper main roller 124 to the in-feed nip point 132 and a line that extends from the center of the upper main roller 124 to a point 78 at which the upper film 122 no longer contacts the upper main roller 124. In the illustrated construction, the encapsulation angle is approximately 130 degrees and in other constructions the encapsulation angle can be more or less than 130 degrees depending on the dwell time required for the particular laminating application.

Comparing the offset roller arrangement to the conventional roller arrangement, in the conventional roller arrangement (FIG. 2), an angle of contact between the film, media, and main rollers is approximately 10 degrees. Therefore, this smaller angle results in the laminating machine 16 having to be operated at a slower speed that the laminating machine 116 in order for the proper dwell time to be achieved.

Referring the FIG. 4, the offset roller arrangement also provides a convenient method of threading the laminating machine 116. One method of threading the laminating machine 116 with the offset roller configuration includes threading the lower film 122 around the lower main roller 126 and through the main and pull roller nips 130, 142. Gravity is utilized to thread the upper film 120 by first threading the film 120 around the tension idler 152 and then allowing the film 120 to fall through the main roller nip 130. Then, the upper film 120 is pulled through the pull roller nip 142. Meanwhile, to facilitate threading, the removable guard 68, the in-feed table 128, and the tension idler 152 can be rotated to a desired position to allow access to the main roller nip 130. Furthermore, the laminating machine 116 with the offset roller arrangement can also include the threading assembly 58 as described above with regard to the laminating machine 16 with the conventional roller arrangement and as illustrated in FIGS. 1 and 2.

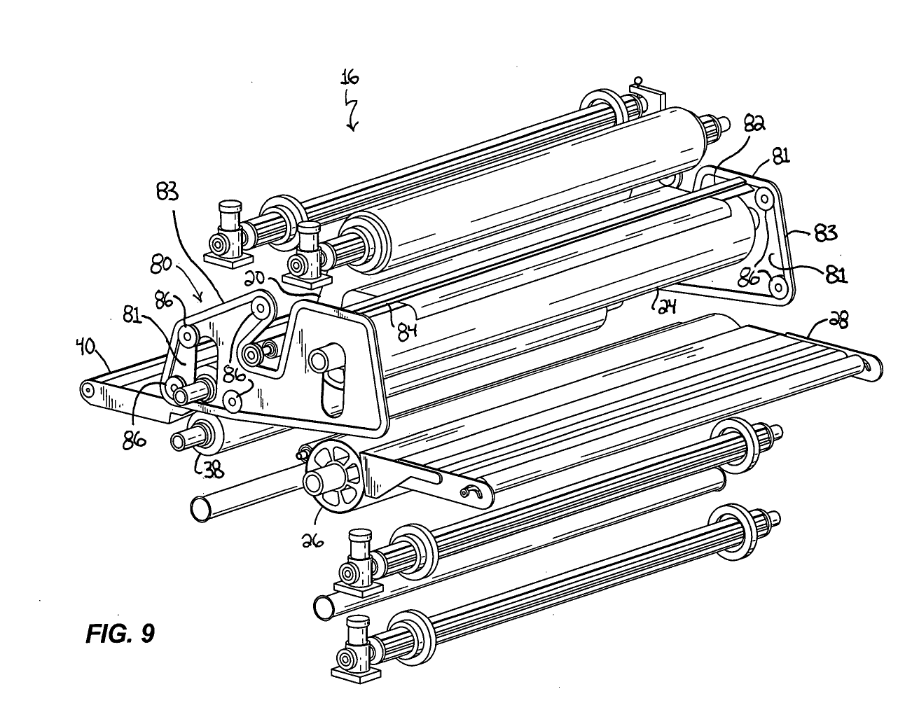

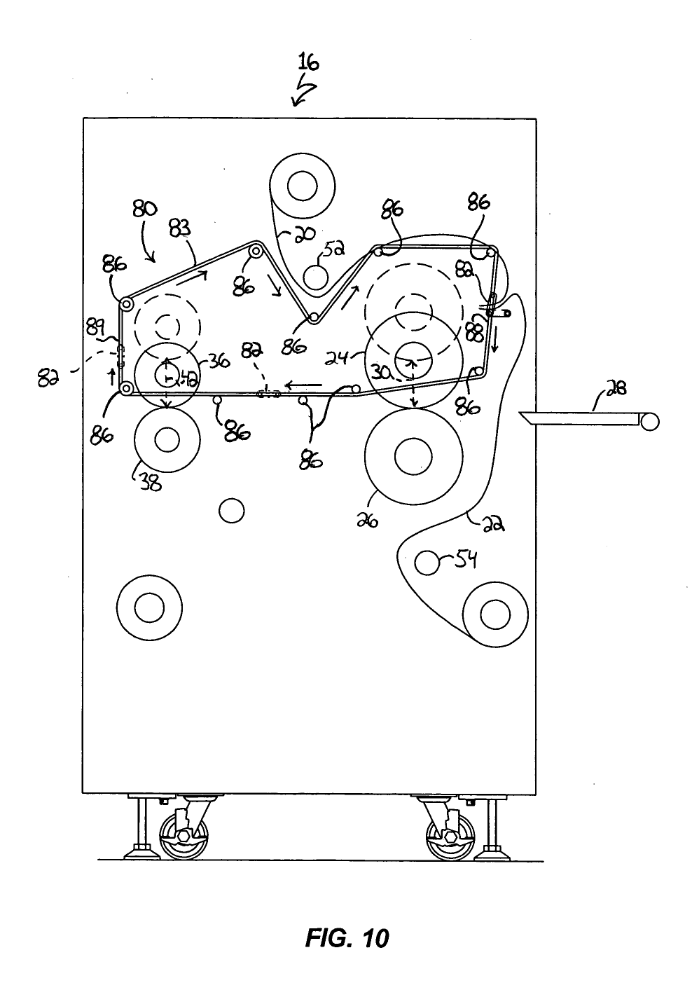

FIGS. 9 and 10 illustrate a second construction of a threading assembly 80 that includes a continuous rail 81 located on each side of the laminating machine 16 and a threading member 82 that extends between each rail 81. The illustrated threading member 82 is a bar movably supported at each end by the rail 81. The threading member 82 includes a clamp 84, or other suitable device, that is configured to engage the upper and lower films 20, 22 with the threading member 82. In other constructions, the threading member 82 may include a slit and can engage the films 20, 22 by threading or weaving the films 20, 22 through the slit.

A flexible member 83 in the form of a chain, belt, etc., is coupled to each end of the threading member 82 and is supported by the rail 81. In other embodiments the rail 81 could be eliminated. A series of guide members 86, such as sprockets, pulleys, and the like are arranged on each side of the laminating machine 16 to guide the flexible member 83 to move the threading member 82 along the rail 81. At least one of the guide members 86 is driven by a drive member, such as a motor or other suitable device, while the remaining guide members 86 free wheel. A push-button, or other suitable device, is configured to operate the drive member to selectively move the threading member 82 along the rail 81 to position the threading member 82 at a desired location.

Referring to FIG. 10, in operation of the threading assembly 80, the threading member 82 is positioned near a location 88 at the front of the laminating machine 16. Then, the free end of the upper film 20 is threaded around the upper tension idler 52 and is engaged with the threading member 82. In alternative method of operation, the threading member 82 can be positioned near a location 89 at the rear of the laminating machine 16 where the upper film 20 can be engaged with the threading member 82, and then the threading member 82 can be moved in the direction indicated by the arrows to the location 88 at the front of the lamination machine 16.

The free end of the lower film 22 is threaded around the lower tension idler 54 and is also engaged with the threading member 82. The threading member 82 is then advanced through the main and pull roller nips 30, 42 as indicated by the arrows and the threading member 82 is stopped when it reaches a location 89 near the rear of the laminating machine 16. The free ends of the upper and lower films 20, 22 are unengaged from the threading member 82 and the main and pull roller nips 30, 42 are closed such that the laminating machine 16 is ready to begin laminating.

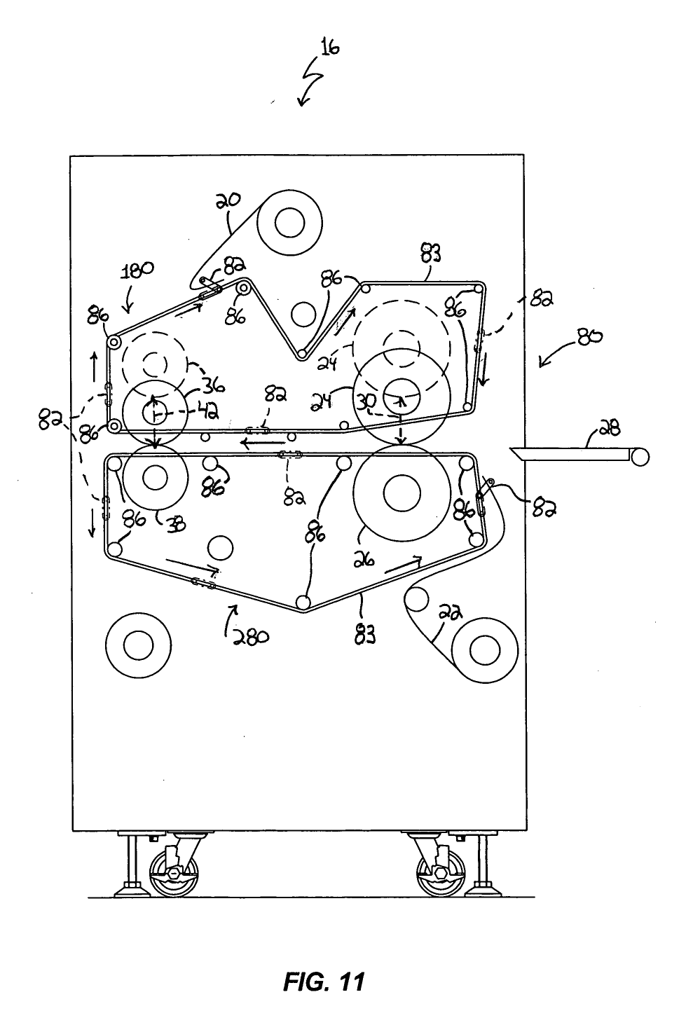

Referring to FIG. 11, in other constructions, the threading assembly 80 can include an upper threading assembly 180 and a lower threading assembly 280. Both of the upper and lower threading assemblies 180, 280 include the flexible member 83, the rail 81, the threading member 82, and the guide members 86 as described above with regard to FIG. 10. The operation of the threading assembly 80 of FIG. 11 is substantially the same as the operation of the threading assembly 80 of FIG. 10. However, during operation of the threading assembly 80 of FIG. 11 the lower film 22 is engaged with the threading member 82 of the lower threading assembly 280 and the upper film 20 is engaged with the threading member 82 of the upper threading assembly 180. Then, the threading members 82 are advanced through the main and pull roller nips 30, 42 as described above with regard to FIG. 10.

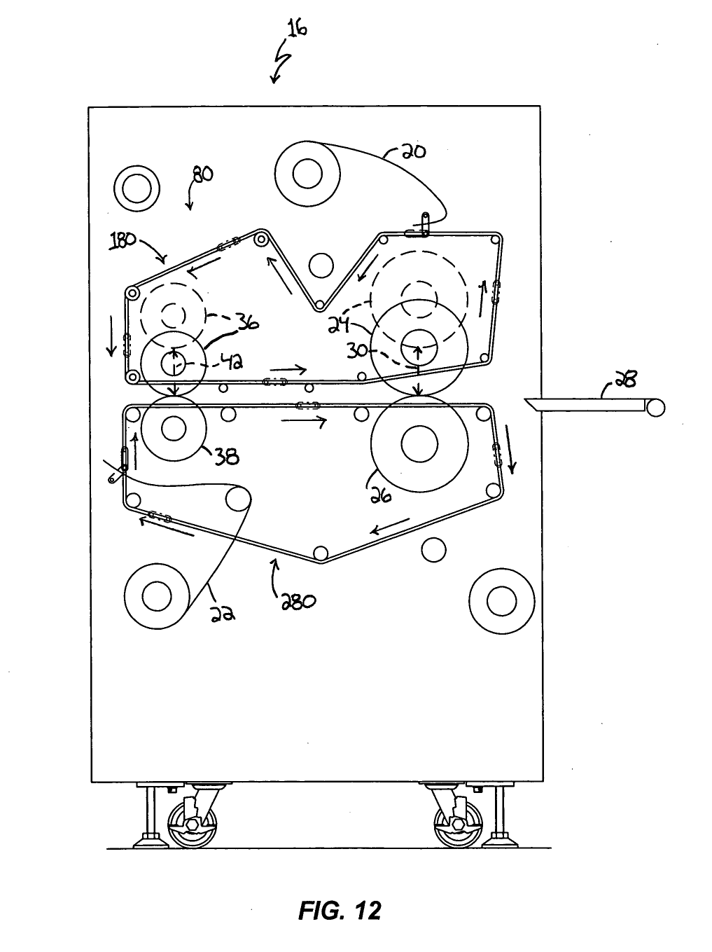

Referring to FIG. 12, the threading assembly 80 is operable in a reverse direction as indicated by the arrows to thread the laminating machine 16 when the laminating machine 16 utilizes pressure sensitive films 20, 22. As is known by one of skill in the art, when laminating using pressure sensitive film, the laminating machine is operated in reverse, such that the media is first fed through the pull roller nip 42 and then exits the laminating machine through the main roller nip 30.

While FIG. 12 illustrates the threading assembly of FIG. 11 that includes the upper and lower threading assemblies 180, 280, threading the laminating machine 16 for use with pressure sensitive films 20, 22 can be accomplished utilizing the single threading mechanism 80 of FIG. 10.

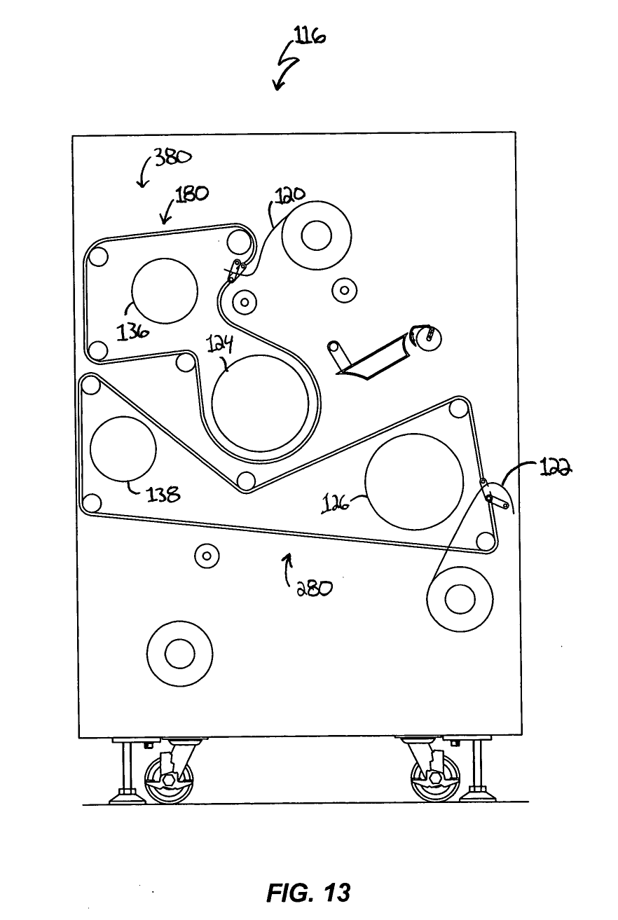

While the threading assembly 80 of FIGS. 9-11 was described with regard to the laminating machine 16 that utilizes the conventional roller arrangement, the threading assembly 80 can also be configured for use with the laminating machine 116 that utilizes the offset roller arrangement. FIG. 13 illustrates one construction of the threading assembly 380 configured for use with the offset roller arrangement, and while the threading assembly 380 of FIG. 13 includes the upper and lower threading assemblies 180, 280, in other constructions the threading assembly 380 may utilized a single threading assembly 80 as described above.

Thus, the invention provides, among other things, a laminating machine 16, 116 that includes a threading assembly, and a laminating machine 116 having offset rollers and a media locking assembly 74. Various features and advantages of the invention are set forth in the following claims.

What is claimed is:

1. A laminating machine configured to apply a film to a media, the laminating machine comprising:
a pair of first rollers defining an in-feed nip;
a pair of second rollers defining an out-feed nip; and
a threading assembly including,
at least one auxiliary roller located between the first pair of rollers and the second pair rollers, the auxiliary roller operable to move a portion of the film from the first roller toward the second roller.

2. The laminating machine of claim 1, wherein the threading assembly further includes a table located between the first pair of rollers and the second pair of rollers, the table including at least one aperture extending therethrough, the table including an air handling unit operable to draw air through the at least one aperature to movably couple the film to a surface of the table.

3. The laminating machine of claim 1, wherein the threading assembly further includes a table located between the first pair of rollers and the second pair of rollers, and wherein the table is an electrostatic table configured to movably couple the film to a surface of the table.

4. The laminating machine of claim 1, wherein the auxiliary roller is operable to move a portion of the film from the in-feed nip through the out-feed nip.

5. The laminating machine of claim 1, wherein the auxiliary roller is coated with a material configured to increase the friction between the auxiliary roller and the film.

6. The laminating machine of claim 1, wherein the threading assembly includes a pair of auxiliary rollers defining an auxiliary roller nip, and wherein the threading assembly is configured to move at least a portion of the film through the auxiliary roller nip and through the out-feed nip.

7. The laminating machine of claim 1, wherein the auxiliary roller is driven by a drive member.

8. The laminating machine of claim 7, wherein the drive member is a motor.

9. A laminating machine configured to apply a film to a media, the laminating machine comprising:
a pair of first rollers defining an in-feed nip;
a pair of second rollers defining an out-feed nip; and
a threading member movable from the in-feed nip toward the out-feed nip, and wherein the threading member is configured to engage the film.

10. The laminating machine of claim 9, wherein the threading member is movable through the in-feed nip and through the out-feed nip.

11. The laminating machine of claim 9, wherein the threading member is driven by a drive member.

12. The laminating machine of claim 11, wherein the drive member is a motor.

13. The laminating machine of claim 11, wherein the drive member is operable to move the threading member in a first direction and a second direction that is opposite the first direction.

14. The laminating machine of claim 9, wherein the threading member moves along a continuous path.

15. The laminating machine of claim 9, wherein the film is a first film and the laminating machine is further configured to apply a second film to the media, wherein the threading member is a first threading member configured to engage the first film, and wherein the laminating machine further comprises a second threading member configured to engage the second film.

16. The laminating machine of claim 9, wherein the threading member is a bar that extends between two sides of the laminating machine.

17. The laminating machine of claim 16, wherein the bar is coupled to a flexible drive member.

18. The laminating machine of claim 17, wherein the flexible drive member is supported by a plurality of guide members.

19. The laminating machine of claim 18, wherein one of the plurality of guide members is driven such that the bar moves from the in-feed nip toward the out-feed nip.
